(19) United States
(12) Patent Application Publication
(10) Pub. No.: US 2025/0278043 A1
(43) Pub. Date: Sep. 4, 2025

(54) FIXING DEVICE INCLUDING CHARGE ELIMINATING BRUSH PROVIDED WITH A PLURALITY OF BRISTLES AND HOLDING FRAME HOLDING THE SAME

(71) Applicant: BROTHER KOGYO KABUSHIKI KAISHA, Nagoya (JP)

(72) Inventors: Shunsuke UEKI, Nagoya (JP); Shinichi HATAKEYAMA, Nagoya (JP)

(73) Assignee: BROTHER KOGYO KABUSHIKI KAISHA, Nagoya (JP)

(21) Appl. No.: 19/068,344

(22) Filed: Mar. 3, 2025

(30) Foreign Application Priority Data
Mar. 4, 2024 (JP) 2024-031858

(51) Int. Cl. G03G 15/20

(52) U.S. Cl. CPC G03G 15/2053; G03G 15/2064

(57) ABSTRACT

A fixing device includes: a heater; an endless belt; and a charge eliminating brush. The heater extends in a first direction. The endless belt is circularly movable around the heater in a rotating direction. The endless belt has an outer peripheral surface. The charge eliminating brush includes: a plurality of bristles which is formed in a bundle; and a holding frame. The holding frame holds the bundle. The bundle has: a proximal end; and a distal end. The proximal end is held by the holding frame. The distal end is configured to contact the outer peripheral surface of the endless belt to remove static charge from the endless belt. The distal end is directed downstream in the rotating direction. The distal end is positioned downstream relative to the proximal end in the rotating direction.

### REFERENCE TO RELATED APPLICATIONS

This application claims priority from Japanese Patent Application No. 2024-031858 filed on Mar. 4, 2024. The entire content of the priority application is incorporated herein by reference.

### BACKGROUND ART

There has been conventionally known a fixing device configured to fix toner images to sheets. The fixing device includes a charge eliminating brush that includes a plurality of bristles. The charge eliminating brush is configured to contact an outer peripheral surface of a belt to remove static charge from the belt.

### SUMMARY

However, one issue with the conventional fixing device described above is that distal ends of the bristles in the charge eliminating brush do not all face in the same direction and, hence, the behavior of the bristles is not stable.

In view of the foregoing, it is an object of the present disclosure to provide a fixing device in which the behavior of all bristles in a charge eliminating brush is stable.

In order to attain the above and other objects, the present disclosure provides a fixing device including: a heater; an endless belt; and a charge eliminating brush. The heater extends in a first direction. The endless belt is circularly movable around the heater in a rotating direction. The endless belt has an outer peripheral surface. The charge eliminating brush includes: a plurality of bristles; and a holding frame. The plurality of bristles is formed in a bundle. The holding frame holds the bundle. The bundle has: a proximal end; and a distal end. The proximal end is held by the holding frame. The distal end is configured to contact the outer peripheral surface of the endless belt to remove static charge from the endless belt. The distal end is directed downstream in the rotating direction. The distal end is positioned downstream relative to the proximal end in the rotating direction.

In the above structure, the distal end of the bundle of the plurality of bristles is directed downstream in the rotating direction and is positioned downstream relative to the corresponding proximal end in the rotating direction, thereby achieving stable behavior of all of the plurality of bristles in the charge eliminating brush.

### BRIEF DESCRIPTION OF DRAWINGS

FIG. 1 is a cross-sectional view illustrating a fixing device.

FIG. 2A is a side view of a heating unit positioned at its first position as viewed in a first direction, and particularly illustrating a charge eliminating brush and one of side guides.

FIG. 2B is a partial enlarged view of the charge eliminating brush illustrated in FIG. 2A.

FIG. 3 is a side view of the heating unit positioned at its second position as viewed in the first direction.

FIG. 4 is an exploded perspective view of the heating unit.

FIG. 5 is an explanatory view of a first contacting area, a first non-contacting area, a second contacting area, and a second non-contacting area in a belt.

FIG. 6A is a schematic cross-sectional view illustrating a configuration in which the charge eliminating brush contacts a surface layer of the belt.

FIG. 6B is a schematic cross-sectional view illustrating a configuration in which the charge eliminating brush contacts a base layer of a belt.

FIG. 6C is a schematic cross-sectional view illustrating a state where the charge eliminating brush contacts a base layer of a belt.

FIG. 7A is a perspective view of the side guide.

FIG. 7B is a cross-sectional view illustrating a positional relationship among the side guide, the belt, and the charge eliminating brush.

FIG. 8 is a cross-sectional perspective view of the fixing device taken along a plane containing the charge eliminating brush.

FIG. 9 is a side view of a heating unit positioned at its first position as viewed in the first direction, and particularly illustrating the charge eliminating brush and one of side guides.

FIG. 10 is a perspective view of the side guide.

FIG. 11 is a cross-sectional perspective view of the fixing device taken along a plane containing the charge eliminating brush.

FIG. 12A is a schematic cross-sectional view illustrating a configuration in which a distal end of the charge eliminating brush faces the one side in the first direction.

FIG. 12B is a schematic cross-sectional view illustrating a configuration in which the distal end of the charge eliminating brush faces the other side in the first direction.

FIG. 13 is a side view of a heating unit positioned at its first position as viewed in the first direction, and particularly illustrating a charge eliminating brush in an inclined state.

### DESCRIPTION

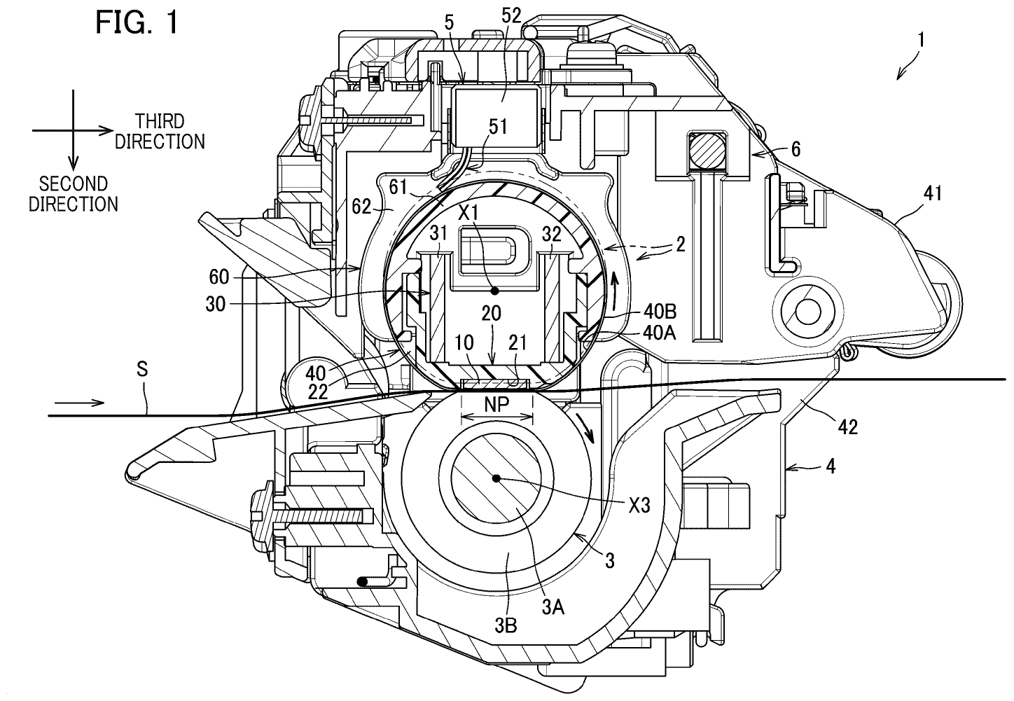

Hereinafter, a first embodiment of the present disclosure will be described in detail while referring to FIGS. 1 to 8. FIG. 1 illustrates a fixing device 1 configured to fix toner images to sheets S. The fixing device 1 is provided in an image forming apparatus such as a printer. The fixing device 1 includes a heating unit 2, a pressure roller 3, a frame 4, a charge eliminating brush 5, and a moving mechanism 6. The heating unit 2 includes a belt 40. The pressure roller 3 is an example of the “pressure-applying rotary body”. The belt 40 is an example of the “endless belt”.

The pressure roller 3 is rotatable about a third axis X3. The pressure roller 3 is configured to, in cooperation with the belt 40, convey a sheet S while nipping the sheet S at a nipping region NP formed between the pressure roller 3 and the heating unit 2. The pressure roller 3 includes a shaft 3A, and an elastic layer 3B. The shaft 3A extends along an axial direction of the pressure roller 3. The elastic layer 3B covers an outer circumferential surface of the shaft 3A.

The frame 4 supports the heating unit 2 and the pressure roller 3. The frame 4 includes a first frame 41 that supports the heating unit 2, and a second frame 42 that supports the pressure roller 3.

The moving mechanism 6 is configured to move the heating unit 2 relative to the pressure roller 3. The moving mechanism 6 is configured to move at least one of the first frame 41 and the second frame 42. In so doing, the moving mechanism 6 is configured to move the heating unit 2 between a first position indicated by solid lines in FIG. 1, and a second position indicated by a phantom line in FIG. 1. Note that only the belt 40 is illustrated by a phantom line in FIG. 1 when the heating unit 2 is at the second position, while the remaining portion of the heating unit 2 is omitted.

In a state where the heating unit 2 is at the first position, the pressing force at the nipping region NP between the heating unit 2 and the pressure roller 3 is a first pressing force. In a state where the heating unit 2 is at the second position, the pressing force at the nipping region NP is a second pressing force that is smaller than the first pressing force. Specifically, in a state where the heating unit 2 is at the first position, the pressure roller 3 presses, at the nipping region NP, the sheet S being conveyed against the heating unit 2 with the first pressing force. Also, in a state where the heating unit 2 is at the second position, the pressure roller 3 presses, at the nipping region NP, the sheet S being conveyed against the heating unit 2 with the second pressing force that is smaller than the first pressing force.

In the following description, the axial direction of the pressure roller 3 will be referred to as “first direction.” Further, a direction in which the heating unit 2 and the pressure roller 3 are arranged and that is orthogonal to the first direction will be referred to as “second direction.” Further, a direction in which sheets S are conveyed at the nipping region NP will be referred to as “third direction.” In the present embodiment, the third direction is orthogonal to both the first direction and the second direction. Note that arrows in the drawings for these directions each point to one side of the respective directions. That is, a leading side of the arrows corresponds to the one side of the respective directions, and a trailing side of the arrows corresponds to the other side of the respective directions.

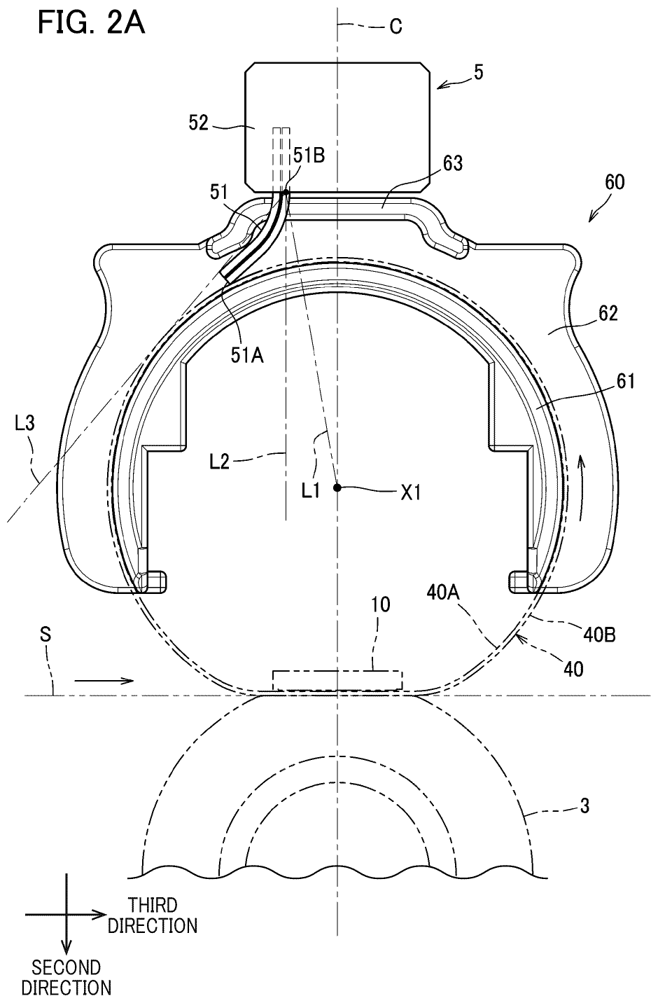

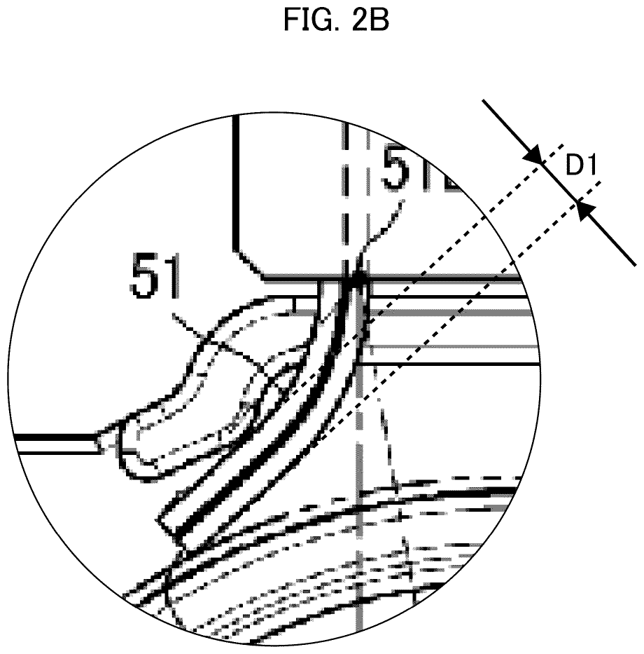

As illustrated in FIGS. 2A and 2B, the charge eliminating brush 5 is a member configured to remove static charge from the belt 40. Specifically, the charge eliminating brush 5 is mounted on the first frame 41 of the frame 4. The charge eliminating brush 5 is grounded by a grounding member (not illustrated).

The charge eliminating brush 5 includes a plurality of bristles 51, and a holding frame 52 holding the plurality of bristles 51.

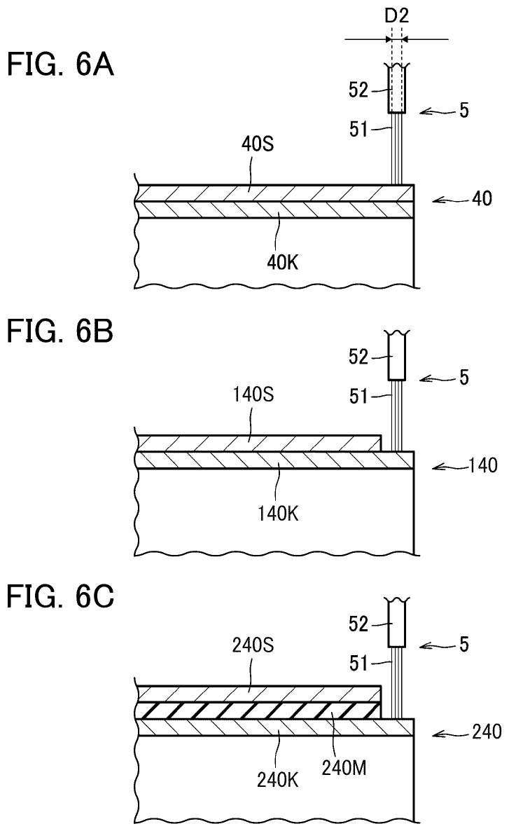

The bristles 51 are formed of electrically conductive fibers. In the present embodiment, the bristles 51 are formed in a bundle of several tens to several hundreds of fibers. The bundle of fibers is arranged in a rotating direction in which the belt 40 is circularly movable. That is, in the present embodiment, a dimension D1 of the bundle of bristles 51 in a direction orthogonal to both the first direction and a fibrous direction (i.e., a direction in which the fibers in the bundle of bristles 51 extend) is greater than a dimension D2 of the bundle of bristles 51 in the first direction (see also FIG. 6A). The bundle of bristles 51 has a distal end 51A and a proximal end 51B.

The proximal end 51B constitutes the root end of a portion of the bundle of bristles 51 that is not fixed in the holding frame 52. In other words, a portion of the bundle of bristles 51 extending from the proximal end 51B to the distal end 51A is a portion of the bundle of bristles 51 that can bend freely.

The distal end 51A of the bristles 51 is configured to contact an outer peripheral surface 40B of the belt 40 to remove static charges from the belt 40. All bristles 51 contacting the belt 40 are oriented such that a portion between the proximal end 51B and the distal end 51A of the bundle of bristles 51 extends along the rotating direction of the belt 40.

Here, an imaginary line that passes through a rotational center X1 of the belt 40 and is orthogonal to the conveying direction of the sheets S will be referred to as “centerline C”. With respect to the third direction, the bristles 51 are arranged only at portions further upstream relative to the centerline C in the conveying direction of the sheets S. When viewed in the third direction, the bristles 51 extend in the second direction from the proximal end 51B (see FIG. 6A). Note that the rotational center X1 of the belt 40 is determined by the shape of a member that guides the belt 40. In the present embodiment, the rotational center X1 of the belt 40 is the diametrical center of inner guides 61 of side guides 60 (described later).

At the proximal end 51B, all bristles 51 extend from the holding frame 52 along a straight line L2 as illustrated in FIG. 2A. That is, at the proximal end 51B, the bristles 51 extend from the holding frame 52 toward the downstream side in the rotating direction of the belt 40 relative to a first straight line L1 connecting the proximal end 51B and the rotational center X1 of the belt 40 to each other. The first straight line L1 is an example of the “straight line”.

For all bristles 51, the straight line L2 indicating a direction in which the bristles 51 extend from the holding frame 52 at the proximal end 51B is closer to the first straight line L1 connecting the proximal end 51B to the rotational center X1 of the belt 40 than to a second straight line L3 that passes through the proximal end 51B and is tangential to the belt 40 at a position upstream relative to the centerline C in the conveying direction of the sheets S (at a position downstream relative to the first straight line L1 in the rotating direction of the belt 40). In other words, the straight line L2 and the first straight line L1 form a first acute angle, and the straight line L2 and the second straight line L3 form a second acute angle. The first acute angle is smaller than the second acute angle.

The holding frame 52 holds the bundle of plurality of bristles 51. Specifically, the holding frame 52 holds the proximal end 51B of the bundle of bristles 51 so that all bristles 51 contacting the belt 40 have at least portions extending along the rotating direction of the belt 40. In other words, the holding frame 52 holds the proximal end 51B while the distal end 51A of the bundle of bristles 51 is directed downstream in the rotating direction of the belt 40 and is positioned downstream relative to the proximal end 51B in the rotating direction of the belt 40.

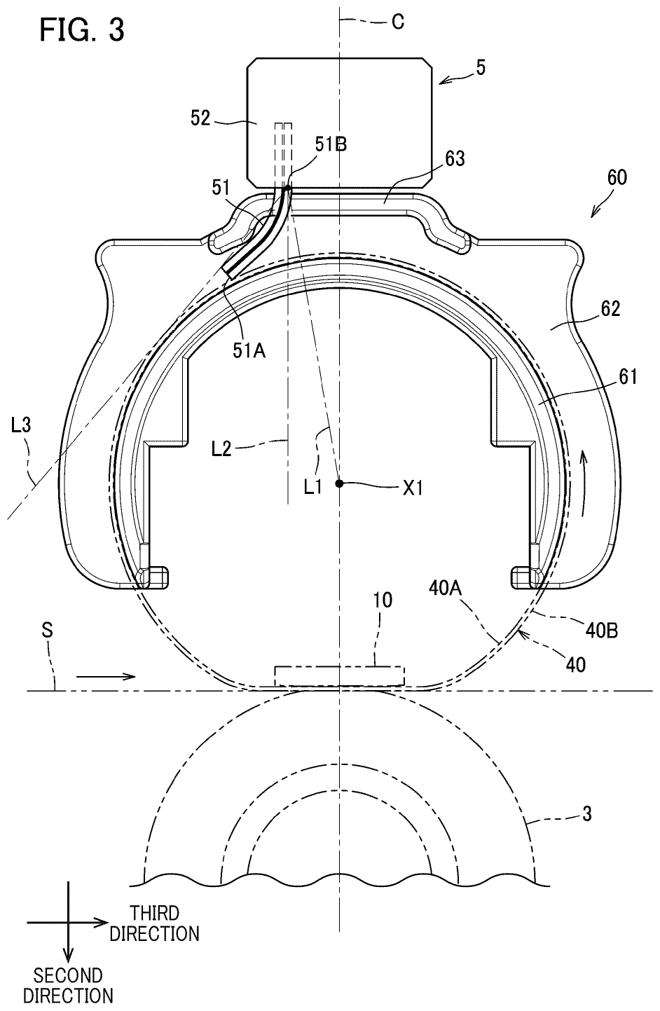

As illustrated in FIG. 3, at least a portion between the proximal end 51B and the distal end 51A of the bundle of bristles 51 extends along the rotating direction of the belt 40, even in a state where the heating unit 2 is at the second position. In other words, a direction in which a portion between the proximal end 51B and the distal end 51A of the bundle of bristles 51 extends is aligned with the rotating direction of the belt 40 both in state where the heating unit 2 is at the first position and in a state where the heating unit 2 is at the second position. Further in other words, both in state where the heating unit 2 is at the first position and in a state where the heating unit 2 is at the second position, the distal end 51A of the bundle of bristles 51 is directed downstream in the rotating direction of the belt 40 and is positioned downstream relative to the proximal end 51B in the rotating direction of the belt 40.

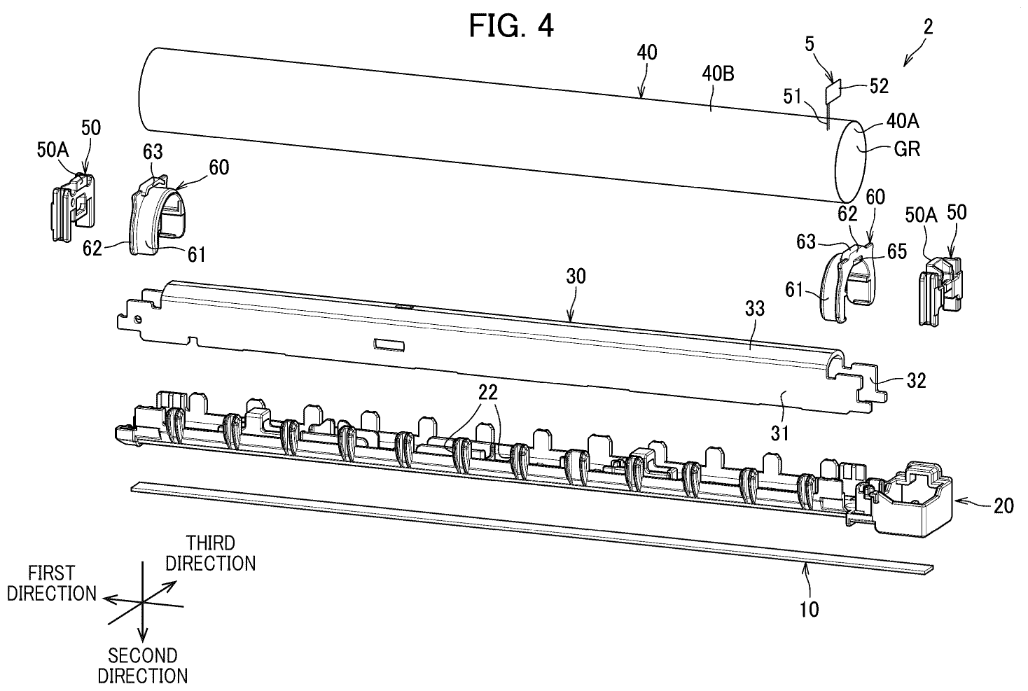

As illustrated in FIG. 4, the heating unit 2 includes a heater 10, a holder 20, a stay 30, the belt 40, side holders 50, and the side guides 60.

The heater 10 is configured to heat the sheets S through the belt 40. The heater 10 has a plate shape that is elongated in the first direction. The heater 10 is in sliding contact with an inner peripheral surface 40A of the belt 40. The heater 10 is known as a ceramic heater.

As illustrated in FIGS. 1 and 4, the holder 20 functions to support the heater 10 and to guide the belt 40. Specifically, the holder 20 has a recess 21, and includes guide ribs 22. The recess 21 is a recessed portion that accommodates therein the heater 10. The plurality of guide ribs 22 is arranged in the first direction for guiding circular movement of the belt 40. The holder 20 is formed of resin, for example.

The stay 30 is a member that supports the holder 20. The stay 30 has a U-shape in a cross-sectional view. The stay 30 is in contact with the holder 20 on the side opposite the heater 10. Specifically, the stay 30 includes a first wall 31, a second wall 32, and a third wall 33. The first wall 31 is a wall that extends in a direction orthogonal to the third direction. An edge of the first wall 31 on the one side in the second direction is in contact with the holder 20. The second wall 32 extends parallel to the first wall 31, and is positioned on the one side of the first wall 31 in the third direction. An edge of the second wall 32 on the one side in the second direction is in contact with the holder 20. The third wall 33 connects an edge of the first wall 31 on the other side in the second direction and an edge of the second wall 32 on the other side in the second direction to each other. The stay 30 is electrically conductive. For example, the stay 30 is formed of metal.

The belt 40 is an endless belt formed of metal, resin, or the like. The belt 40 is circularly movable around the heater 10 in the rotating direction while being guided by the holder 20. The belt 40 forms the nipping region NP at a position between the belt 40 and the pressure roller 3. The belt 40 circularly moves while being in contact with the pressure roller 3 to convey the sheets S in cooperation with the pressure roller 3. The belt 40 has the inner peripheral surface 40A, and the outer peripheral surface 40B.

The inner peripheral surface 40A is in contact with the heater 10. Grease GR serving as an example of the lubricant is provided on the inner peripheral surface 40A of the belt 40. While there is no particular restriction on the type of grease GR, the grease GR in the present embodiment uses a fluorinated oil as the base oil and includes a thickener and additives.

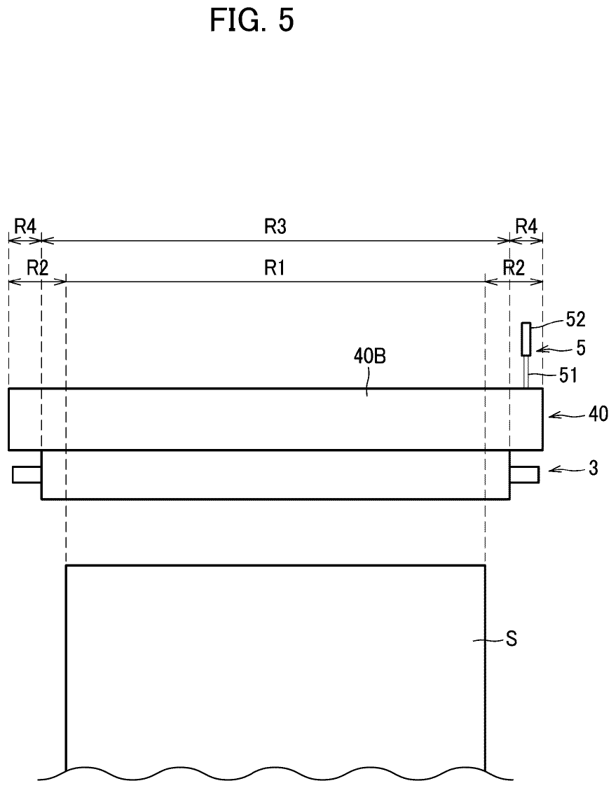

The outer peripheral surface 40B of the belt 40 is configured to contact the pressure roller 3 or the sheet S to be heated. As illustrated in FIG. 5, the outer peripheral surface 40B of the belt 40 has a first contacting area R1 configured to contact the sheet S when the belt 40 conveys the sheet S in cooperation with the pressure roller 3, and first non-contacting areas R2 not contacting the sheet S when the belt 40 conveys the sheet S in cooperation with the pressure roller 3. The bristles 51 of the charge eliminating brush 5 are configured to contact one of the first non-contacting areas R2, and do not contact the first contacting area R1. The first contacting area R1 is an example of the “contacting area configured to contact the sheet”, and the first non-contacting areas R2 are examples of the “contacting area not contacting the sheet”.

The outer peripheral surface 40B of the belt 40 also has a second contacting area R3 configured to contact the pressure roller 3, and second non-contacting areas R4 not contacting the pressure roller 3. The bristles 51 of the charge eliminating brush 5 are configured to contact one of the second non-contacting areas R4, and do not contact the second contacting area R3. The second contacting area R3 is an example of the “contacting area configured to contact the pressure-applying rotary body”, and the second non-contacting areas R4 are examples of the “non-contacting area not contacting the pressure-applying rotary body”.

As illustrated in FIG. 6A, the belt 40 includes a base layer 40K, and a surface layer 40S. The surface layer 40S covers the base layer 40K. The surface layer 40S is a layer configured to contact the sheets S. In the present embodiment, the bristles 51 of the charge eliminating brush 5 are configured to contact the surface layer 40S, and do not contact the base layer 40K.

As illustrated in FIG. 4, the side holders 50 are attached to both end portions in the first direction of the stay 30, respectively. That is, one side holder 50 is attached to each end portion of the stay 30. The two side holders 50 have shapes the same as each other. Each of the side holders 50 has a contact surface 50A that contacts a corresponding one of the side guides 60 (described later). The side holders 50 are formed of resin, for example.

The side guides 60 are provided one on both end portions in the first direction of the belt 40, respectively. The side guides 60 are attached to the stay 30 so as to be pivotally movable. The two side guides 60 are provided so as to contact the respective end portions in the first direction of the belt 40 to guide these end portions of the belt 40. In the present embodiment, the side guides 60 have shapes the same as each other.

Each of the side guides 60 includes the inner guide 61, an end face guide 62, a restriction rib 63, and a protrusion 65.

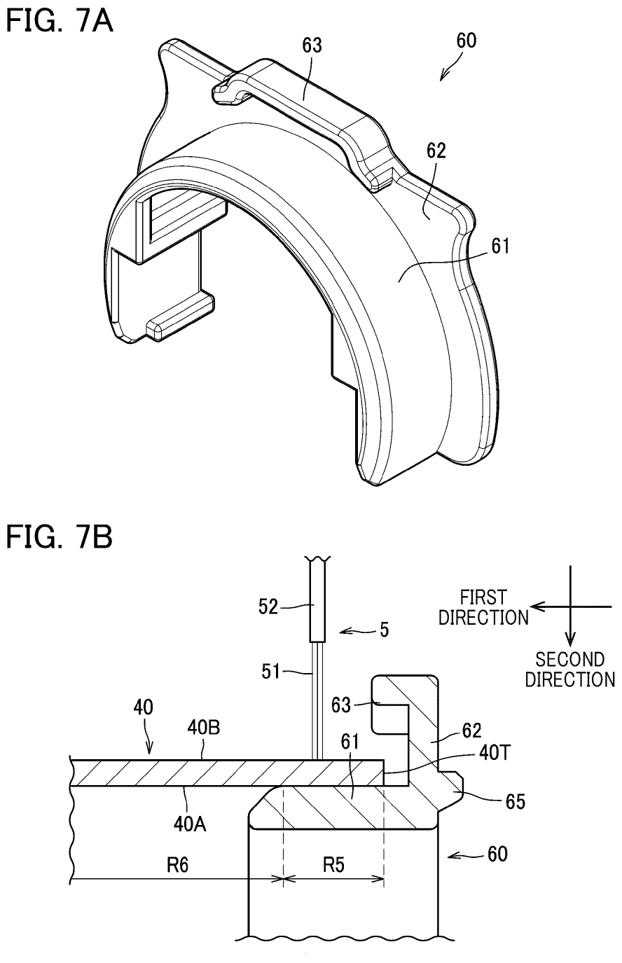

As illustrated in FIGS. 7A and 7B, each of the inner guides 61 is in contact with a corresponding end portion of the inner peripheral surface 40A of the belt 40 in the first direction, and is configured to guide the circular movement of the belt 40. Each of the inner guides 61 extends in a shape of an arc. Each of the inner guides 61 has a circumferential length for guiding 50-80% of the end portion of the belt 40 along a circumferential direction of the belt 40. The grease GR is arranged between the inner guides 61 and the inner peripheral surface 40A of the belt 40.

The belt 40 also has contacting portions R5 configured to contact the inner guides 61 of the corresponding side guides 60, and a non-contacting portion R6 not contacting the inner guides 61. The bristles 51 of the charge eliminating brush 5 are configured to contact one of the contacting portions R5, but do not contact the non-contacting portion R6.

Each of the end face guides 62 faces and is configured to contact an end face 40T of the corresponding end portion of the belt 40 in the first direction. Each of the end face guides 62 is configured to guide the corresponding end face 40T of the belt 40. Specifically, each of the end face guides 62 is brought into contact the end face 40T when the belt 40 moves toward the end face guide 62 in the first direction to restrict further displacement of the belt 40 in the first direction.

Each of the end face guides 62 extends from the corresponding inner guide 61 in a direction orthogonal to the first direction. Each of the end face guides 62 is in a form of a flange that extends radially outward from the diametrical center of the corresponding inner guide 61. Each of the end face guides 62 need not be always in contact with the corresponding end face 40T of the belt 40, but may contact or separate from the corresponding end face 40T depending on the behavior of the belt 40.

Each of the restriction ribs 63 protrudes in the first direction from the corresponding end face guide 62. Each of the restriction ribs 63 extends in the third direction so as to cover only an upper portion of the belt 40 on the corresponding end portions thereof. One of the restriction ribs 63 is configured to contact the bristles 51 of the charge eliminating brush 5. Specifically, the one of the restrictions rib 63 contacts the bristles 51 when the bristles 51 move in the first direction.

As illustrated in FIG. 4, each of the protrusions 65 is a part that protrudes in the first direction from the corresponding end face guide 62. Each of the protrusions 65 protrudes to the opposite side of the corresponding end face guide 62 from the corresponding inner guide 61. Each of the protrusion 65 has an arc surface. With the arc surface of the protrusion 65 contacting the contact surface 50A of the corresponding side holder 50, each of the side guides 60 is pivotally movable relative to the holder 20.

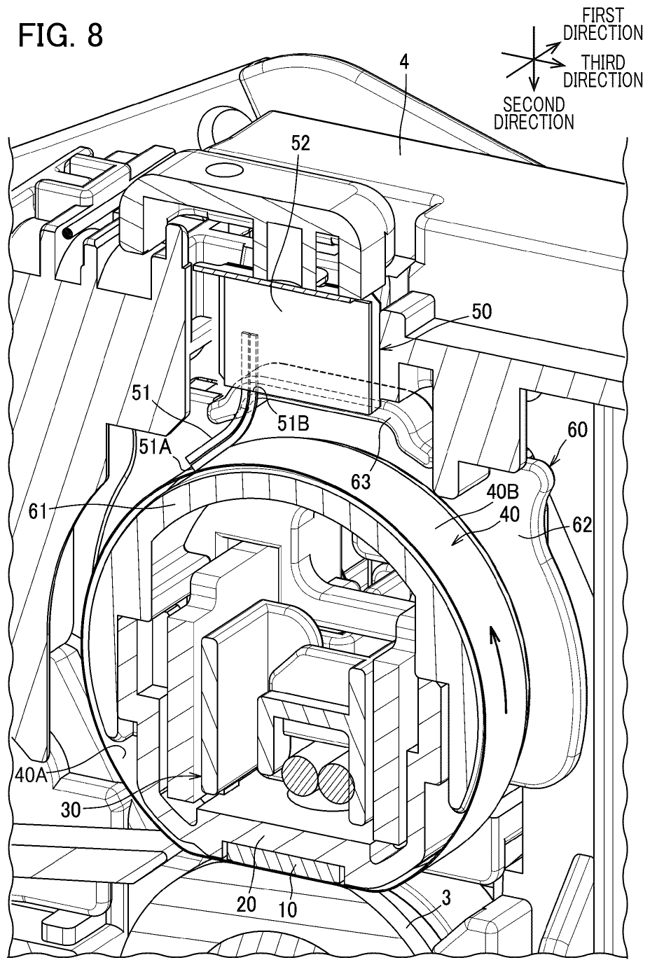

Next, the operation of the charge eliminating brush 5 in the fixing device 1 having the above configuration will be described with reference to FIG. 8.

As illustrated in FIG. 8, the bristles 51 of the charge eliminating brush 5 extend from the proximal end 51B toward the belt 40. The distal end 51A of the bundle of bristles 51 contacts the outer peripheral surface 40B of the belt 40. This contact between the distal end 51A and the belt 40 bends the bristles 51 into such an orientation that at least portions of the bristles 51 extend along the rotating direction of the belt 40. In this way, portions between the proximal end 51B and the distal end 51A of all bristles 51 which are in contact with the belt 40 extend along the rotating direction of the belt 40.

The distal end 51A of the bundle of bristles 51 may move toward the one side or the other side in the first direction due to displacement of the belt 40 in the first direction. If the bristles 51 move toward the other side of the first direction, the bristles 51 may come into contact with the restriction rib 63 of one of the side guides 60. However, since the restriction rib 63 restricts movement of the bristles 51 when the bristles 51 contact the restriction rib 63, the bristles 51 are restricted from moving further toward the other side in the first direction.

The first embodiment described above can obtain the following technical advantages. According to the fixing device 1 of the first embodiment, the holding frame 52 of the charge eliminating brush 5 holds the bristles 51 so that portions, between the proximal end 51B and the distal end 51A, of all bristles 51 contacting the belt 40 extend along the rotating direction of the belt 40. This arrangement ensures stable behavior of all bristles 51 in the charge eliminating brush 5.

Further, the bristles 51 of the charge eliminating brush 5 is configured to contact one of the first non-contacting areas R2 and do not contact the first contacting area R1. This arrangement would suppress such foreign matter from being transferred onto the sheets S if foreign matter were to become deposited on the bristles 51.

Further, the bristles 51 of the charge eliminating brush 5 is configured to contact one the second non-contacting areas R4 and do not contact the second contacting area R3. This arrangement would suppress such foreign matter from being transferred onto the pressure roller 3 if foreign matter were to become deposited on the bristles 51.

Further, by contacting the restriction rib 63 of the side guide 60 when moving in the first direction, the bristles 51 can be restricted from moving further in the first direction.

Since the bristles 51 is configured to contact one of the contacting portions R5, the charge eliminating brush 5 does not affect the behavior of the belt 40 even when contacting the belt 40. Accordingly, this arrangement can suppress unstable behavior of the belt 40.

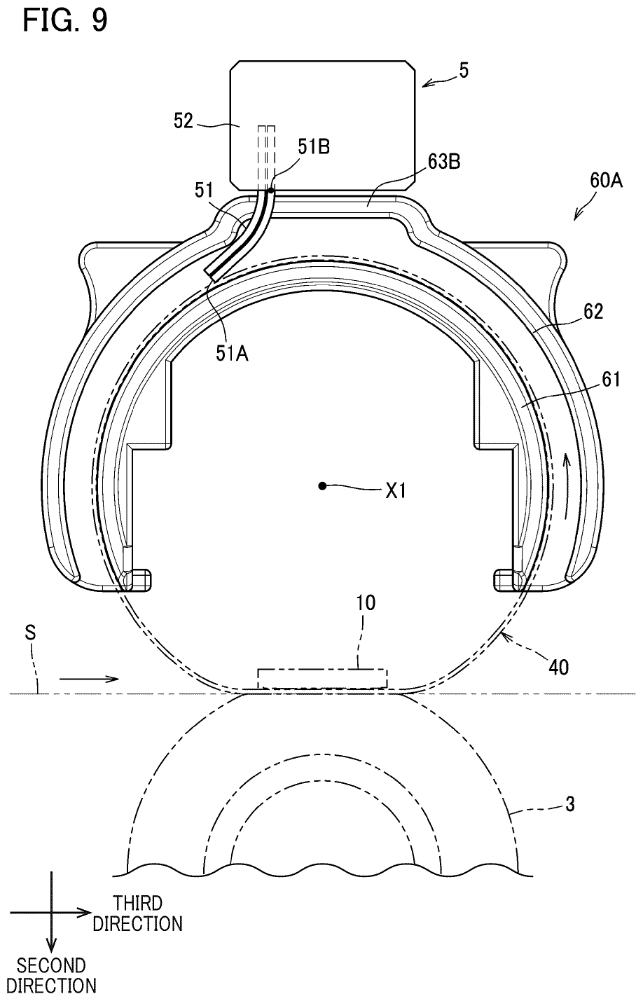

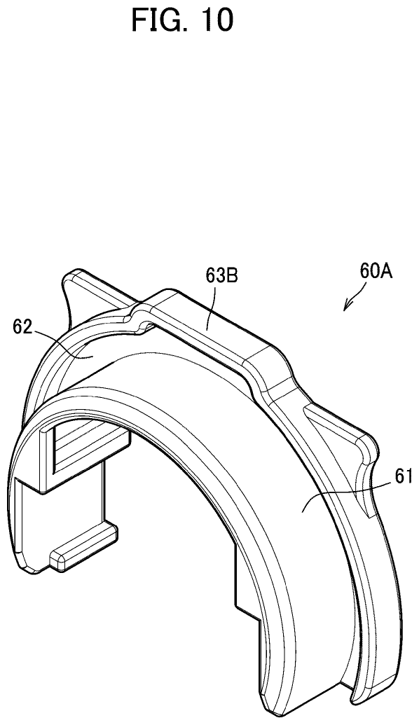

Next, a second embodiment of the present disclosure will be described with reference to FIGS. 9 to 11. The second embodiment differs from the first embodiment in the shape of the side guides. Note that parts and components of the fixing device 1 in the second embodiment that are common to those in the first embodiment are designated with the same reference numbers to avoid duplicating description.

FIGS. 9 and 10 illustrate one of side guides 60A in the second embodiment. The side guide 60A includes a restriction rib 63B. While the restriction ribs 63 in the first embodiment extend in the third direction so as to cover only the upper portion of the belt 40 (see FIGS. 2A and 3) on the corresponding end portions, the restriction rib 63B in the second embodiment extends to cover not only the upper portion but also side portions of the end portion of the belt 40. Specifically, the restriction rib 63B is formed in an arc shape. The restriction rib 63B extends in the circumferential direction over the same range as the inner guide 61, i.e., a range of 50-80% of the end portion of the belt 40 along the circumferential direction.

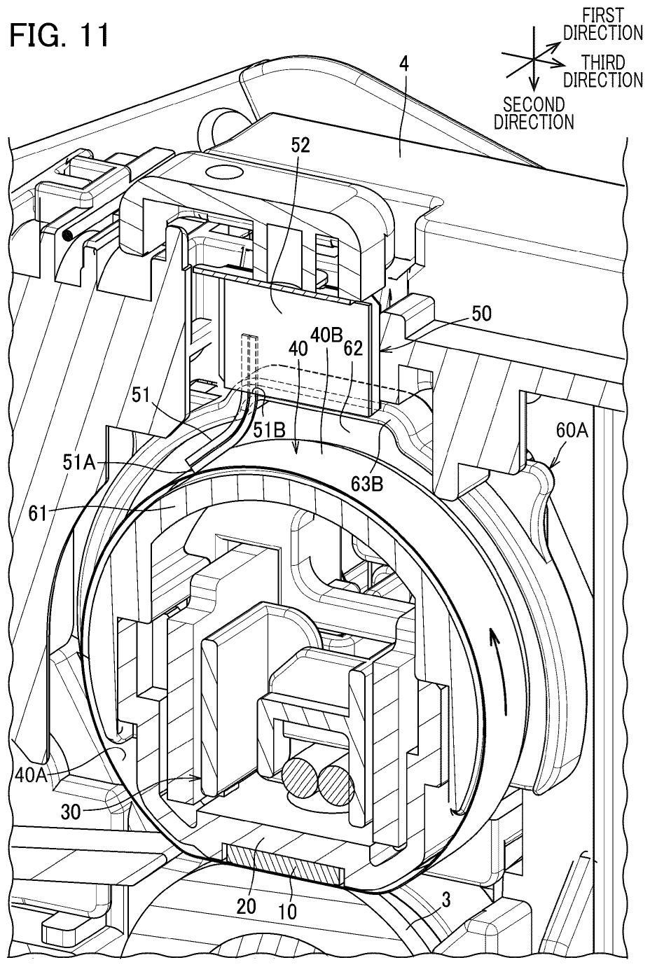

As illustrated in FIG. 11, if the bristles 51 were to move toward the other side in the first direction, the bristles 51 would contact the restriction rib 63B of the side guide 60A in the second embodiment as well. When the bristles 51 contact the restriction rib 63B, the bristles 51 are restricted from moving further in the first direction.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

In the embodiments described above, the belt 40 includes the surface layer 40S and the base layer 40K, and the bristles 51 of the charge eliminating brush 5 are configured to contact the surface layer 40S (see FIG. 6A). However, the belt 40 may have a configuration different from that in FIG. 6A. According to a modification illustrated in FIG. 6B, a belt 140 includes a surface layer 140S, and a base layer 140K. The bristles 51 are configured to contact the base layer 140K, and do not contact the surface layer 140S. Since the bristles 51 make contact with the base layer 140K in this configuration, the charge eliminating brush 5 can stably remove static charge from the base layer 140K of the belt 140. Further, if foreign matter were to become deposited on the bristles 51, this arrangement could suppress such foreign matter from being transferred onto the surface layer 140S of the belt 140.

Although the belt 40 is configured of the surface layer 40S and the base layer 40K in the above embodiments, still another configuration may be employed. In a modification illustrated in FIG. 6C, a belt 240 includes a surface layer 240S, a base layer 240K, and an intermediate layer 240M positioned between the surface layer 240S and the base layer 240K. In this configuration, the bristles 51 of the charge eliminating brush 5 are configured to contact the base layer 240K, but do contact the surface layer 240S or the intermediate layer 240M. Note that this modification can exhibit the advantages the same as those in FIG. 6B.

In the embodiments described above, the bundle of bristles 51 is arranged so that the dimension D1 of the bundle of bristles 51 in the direction orthogonal to both the first direction and the fibrous direction in which the fibers in the bristles 51 extend at the distal end 51A is greater than the dimension D2 of the bundle of bristles 51 in the first direction. However, the bundle of bristles 51 may be arranged so that the dimension D2 of the bundle of bristles 51 in the first direction is greater than the dimension D1 of the bundle of bristles 51 in the direction orthogonal to both the first direction and the fibrous direction (not illustrated).

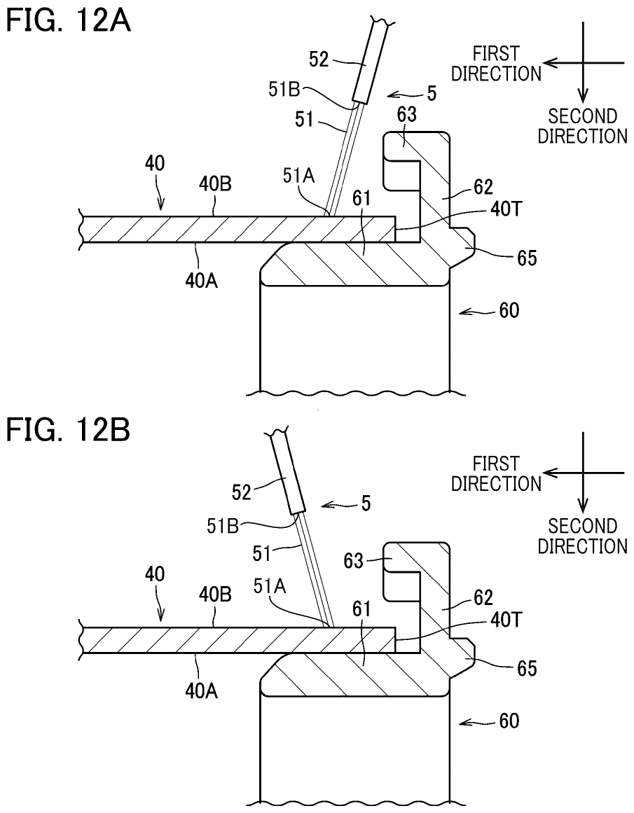

In the above embodiments, the charge eliminating brush 5 extends in the second direction when viewed in the third direction (see FIG. 7B). However, the entirety of the charge eliminating brush 5 may have a tilted arrangement such that the distal end 51A of the bundle of bristles 51 faces the one side in the first direction when viewed in the third direction, as illustrated in FIG. 12A. Put another way, if the belt 40 has one end and another end in the first direction and the charge eliminating brush 5 is positioned closer to the one end of the belt 40 than to the other end of the belt 40, all bristles 51 of the charge eliminating brush 5 would be inclined so that their portions from the proximal end 51B to the distal end 51A advance from the one end of the belt 40 toward the other end. Further in other words, all bristles 51 are inclined such that the distal end 51A of the bundle of bristles 51 is closer to the other end of the belt 40 than the proximal end 51B of the bundle of bristles 51 is to the other end of the belt 40.

Alternatively, the entirety of the charge eliminating brush 5 may have a tilted arrangement in which the distal end 51A of the bundle of bristles 51 faces the other side in the first direction when viewed in the third direction, as illustrated in FIG. 12B. In other words, all bristles 51 are inclined such that the distal end 51A of the bundle of bristles 51 is closer to the one end of the belt 40 than the proximal end 51B of the bundle of bristles 51 is to the one end of the belt 40.

In the embodiments described above, at the proximal end 51B, all bristles 51 extend from the holding frame 52 along the straight line L2. The straight line L2 is closer to the first straight line L1 connecting the proximal end 51B to the rotational center X1 of the belt 40 than the second straight line L3 that passes through the proximal end 51B and is tangential to the belt 40 at a position upstream relative to the centerline C in the conveying direction of the sheets S (at a position downstream relative to the first straight line L1 in the rotating direction of the belt 40). However, the present disclosure is not limited to this configuration.

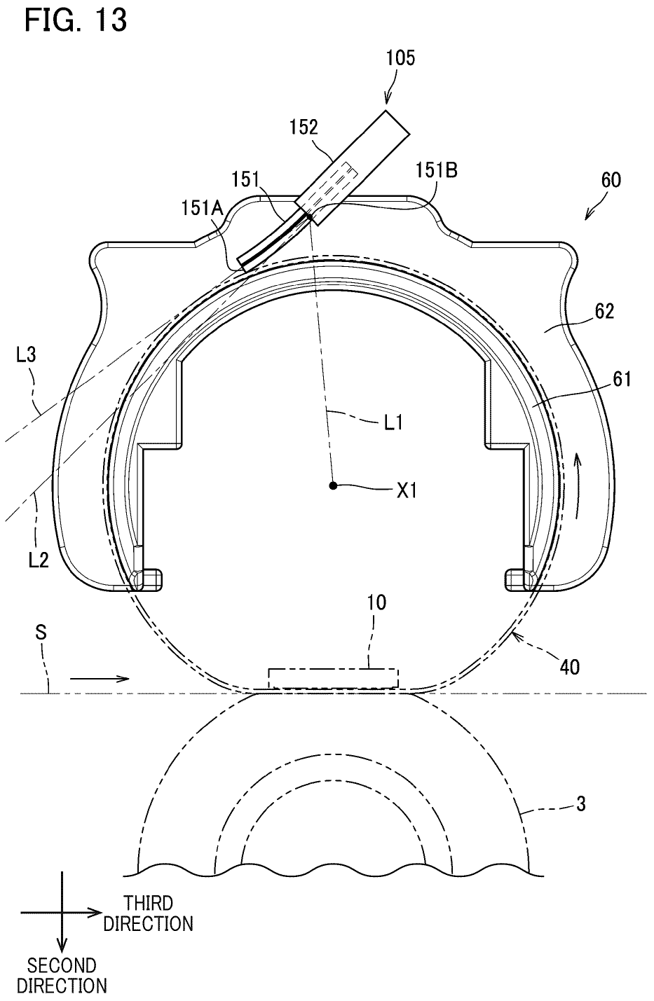

FIG. 13 illustrates a charge eliminating brush 105 according to a modification. This charge eliminating brush 105 includes a plurality of bristles 151, and a holding frame 152 that holds the bristles 151. The plurality of bristles 151 is formed in a bundle. The bundle of bristles 151 has a distal end 151A and a proximal end 151B. All bristles 151 extend from the holding frame 152 in a direction along a straight line L2 at the proximal end 151B.

In this modification, the straight line L2 is closer to a second straight line L3 than to a first straight line L1. The second straight line L3 passes through the proximal end 151B of the bundle of bristles 151 and is tangential to the belt 40 at a position downstream relative to the first straight line L1 in the rotating direction of the belt 40 (at a position upstream relative to the centerline C in the conveying direction of the sheets S), and the first straight line L1 connects the proximal end 151B and the rotational center X1 of the belt 40 to each other.

In other words, the straight line L2 and the first straight line L1 form the first acute angle, and the straight line L2 and the second straight line L3 form the second acute angle. This modification differs from the embodiments in that the second acute angle is smaller than the first acute angle. In this modification, the straight line L2 is an example of the “first straight line”, the first straight line L1 is an example of the “second straight line”, and the second straight line L3 is an example of the “third straight line”.

With this configuration, the holding frame 152 of the charge eliminating brush 105 holds the plurality of bristles 151 such that at least portions between the proximal end 151B and the distal end 151A of all bristles 151 contacting the belt 40 extend along the rotating direction of the belt 40. Accordingly, this configuration can also stabilize the behavior of the bristles 151 in the charge eliminating brush 105.

The charge eliminating brush 5 in the above embodiments is formed of electrically conductive fibers. However, the charge eliminating brush 5 may be formed of another material such as stainless steel or another metal as long as the other material has electrical conductivity.

The elements appearing in the embodiments and modifications described above may be implemented in any suitable combination.

What is claimed is:

1. A fixing device comprising:
a heater extending in a first direction;
an endless belt circularly movable around the heater in a rotating direction, the endless belt having an outer peripheral surface; and
a charge eliminating brush comprising:
a plurality of bristles which is formed in a bundle; and
a holding frame holding the bundle,
wherein the bundle has:
a proximal end held by the holding frame; and
a distal end configured to contact the outer peripheral surface of the endless belt to remove static charge from the endless belt, the distal end being directed downstream in the rotating direction, the distal end being positioned downstream relative to the proximal end in the rotating direction.

2. The fixing device according to claim 1, further comprising:
a pressure-applying rotary body configured to contact the endless belt, the pressure-applying rotary body being configured to convey a sheet in cooperation with the endless belt,
wherein the outer peripheral surface has:
a contacting area configured to contact the sheet when the endless belt and the pressure-applying rotary body convey the sheet; and
a non-contacting area not contacting the sheet when the endless belt and the pressure-applying rotary body convey the sheet, and
wherein the plurality of bristles is configured to contact the non-contacting area and does not contact the contacting area.

3. The fixing device according to claim 1, further comprising:
a pressure-applying rotary body configured to contact the endless belt, the pressure-applying rotary body being configured to convey a sheet in cooperation with the endless belt,
wherein the outer peripheral surface has:
a contacting area configured to contact the pressure-applying rotary body; and
a non-contacting area not contacting the pressure-applying rotary body, and
wherein the plurality of bristles is configured to contact the non-contacting area and does not contact the contacting area.

4. The fixing device according to claim 1,
wherein the endless belt comprises:
a base layer; and
a surface layer covering the base layer, the surface layer being configured to contact a sheet, and
wherein the plurality of bristles is configured to contact the base layer and does not contact the surface layer.

5. The fixing device according to claim 1,
wherein the endless belt comprises:
a base layer;
a surface layer covering the base layer, the surface layer being configured to contact a sheet; and
an intermediate layer positioned between the base layer and the surface layer, and
wherein the plurality of bristles is configured to contact the base layer and does not contact the surface layer or the intermediate layer.

6. The fixing device according to claim 1,
wherein the endless belt comprises:
a base layer; and
a surface layer covering the base layer, the surface layer being configured to contact a sheet, and
wherein the plurality of bristles is configured to contact the surface layer and does not contact the base layer.

7. The fixing device according to claim 1,
wherein the endless belt has an end face in the first direction,
the fixing device further comprising:
a side guide configured to contact the endless belt to guide the endless belt, the side guide comprising:
an end face guide configured to contact the end face of the endless belt to restrict displacement of the endless belt in the first direction; and
a restriction rib protruding in the first direction from the end face guide, the restriction rib being configured to contact the plurality of bristles.

8. The fixing device according to claim 1,
wherein the endless belt further has an inner peripheral surface, the inner peripheral surface having an end portion in the first direction,
the fixing device further comprising:
an inner guide in contact with the end portion of the inner peripheral surface to guide circular movement of the endless belt,
wherein the endless belt has:
a contacting portion in contact with the inner guide; and
a non-contacting portion not contacting the inner guide, and
wherein the plurality of bristles is configured to contact the contacting portion and does not contact the non-contacting portion.

9. The fixing device according to claim 1, further comprising:
a heating unit comprising the heater and the endless belt;
a pressure-applying rotary body configured to contact the endless belt, the pressure-applying rotary body being configured to, in cooperation with the endless belt, convey a sheet while nipping the sheet at a nipping region formed between the pressure-applying rotary body and the endless belt; and
a moving mechanism configured to move the heating unit relative to the pressure-applying rotary body between a first position and a second position,
wherein, in a state where the heating unit is at the first position, the pressure-applying rotary body presses, at the nipping region, the sheet being conveyed against the heating unit with a first pressing force,
wherein, in a state where the heating unit is at the second position, the pressure-applying rotary body presses, at the nipping region, the sheet being conveyed against the heating unit with a second pressing force that is smaller than the first pressing force, and
wherein, both in a state where the heating unit is at the first position and in a state where the heating unit is at the second position, the distal end is directed downstream in the rotating direction and is positioned downstream relative to the proximal end in the rotating direction.

10. The fixing device according to claim 1,
wherein a dimension of the bundle in a direction orthogonal to both the first direction and a fibrous direction is greater than a dimension of the bundle in the first direction, the fibrous direction being a direction in which fibers in the bundle extend.

11. The fixing device according to claim 1,
wherein the endless belt has one end and an other end in the first direction,
wherein the charge eliminating brush is positioned closer to the one end of the endless belt than to the other end of the endless belt, and
wherein each of all of the plurality of bristles is inclined such that the distal end is closer to the other end of the endless belt than the proximal end is to the other end of the endless belt.

12. The fixing device according to claim 1,
wherein the endless belt has one end and an other end in the first direction,
wherein the charge eliminating brush is positioned closer to the one end of the endless belt than to the other end of the endless belt, and
wherein each of all of the plurality of bristles is inclined such that the distal end is closer to the one end of the endless belt than the proximal end is to the one end of the endless belt.

13. The fixing device according to claim 1,
wherein, at the proximal end, each of all of the plurality of bristles extends from the holding frame toward a downstream side relative to a straight line in the rotating direction, the straight line connecting the proximal end and a rotational center of the endless belt to each other.

14. The fixing device according to claim 1,
wherein, at the proximal end, each of all of the plurality of bristles extends from the holding frame along a first straight line, the first straight line and a second straight line forming a first acute angle, the first straight line and a third straight line forming a second acute angle that is smaller than the first acute angle, the second straight line connecting the proximal end and a rotational center of the endless belt to each other, the third straight line passing through the proximal end and tangential to the endless belt at a position downstream relative to the second straight line in the rotating direction.
